(19) United States
(12) Patent Application Publication
(10) Pub. No.: US 2024/0181453 A1
(43) Pub. Date: Jun. 6, 2024

(54) MICROFLUIDIC CHIP

(71) Applicant: EMULTECH B.V., Eindhoven (NL)

(72) Inventors: Petrus Casper Martinus VAN STIPHOUT, Eindhoven (NL); Tom DERKS, Eindhoven (NL); Ferdi Raymon VAN DER WEIJDEN, Eindhoven (NL)

(21) Appl. No.: 18/553,759

(22) PCT Filed: Apr. 2, 2022
(86) PCT No.: PCT/NL2022/050186

§ 371 Date: Oct. 3, 2023

(30) Foreign Application Priority Data
Apr. 3, 2021 (NL) 2027915

(51) Int. Cl. B01L 3/00

(52) U.S. Cl. CPC B01L 3/502746; B01L 3/502784; B01L 2300/0867; B01L 2400/086

(57) ABSTRACT

The invention relates to a microfluidic chip comprising at least two units for droplet formation, each unit comprising a first supply channel for supplying a first phase, a second supply channel for supplying a second phase and a discharge channel for discharging a product phase, wherein the first and second supply channel converge at a junction to the discharge channel. The hydraulic resistance of the supply channels is higher than that of the discharge channel, so that there is a better flow at the junction, yielding droplets of higher uniformity. In a preferred embodiment, there is a manifold that feeds all the units for droplet formation in a parallel fashion, wherein the manifold has at least a ten times lower hydraulic resistance than the supply channels in the units for droplet formation. This results in droplets that have an even higher uniformity. Another advantage, especially with higher numbers of units for droplet formation in the chip, is that there is less disturbance of liquid flow by gas bubbles and less inactivity of channels when starting a process in the microfluidic chip.

### FIELD OF THE INVENTION

The invention relates to a microfluidic chip, to a cartridge comprising such microfluidic chip, to an assembly comprising the cartridge and to a method for the manufacture of droplets, vesicles, microparticles or nanoparticles comprising the use of such microfluidic chip.

### BACKGROUND

Microfluidic devices have been used to generate a wide variety of (micro)droplets, vesicles, microparticles and nanoparticles with a degree of control over their size, shape, and composition that is not possible with conventional methods. These microfluidic devices utilize a flow geometry which takes advantage of the fluid dynamics through microfluidic channels to generate individual droplets surrounded by a continuous medium. The simplest droplet generator geometry consists of a T-junction, in which one channel is orthogonal to a second channel. A first liquid flows through one channel and shears off droplets of a second liquid in the second channel when two immiscible solvents are used or creates a very controlled gradient when to miscible solvents are used. By controlling the flow rates of the two liquids, the droplet size can be accurately controlled.

A more complex geometry of a droplet generator consists of an X-junction, having two channels orthogonal to a third channel. When two immiscible solvents meet at the X-junction, droplets of one solvent surrounded by the second immiscible solvent are created. When two miscible solvents are used, a stream of one solvent that is getting thinner and thinner is created. This leads to a concentration gradient and in the end to nanoprecipitation of components present in the stream, yielding particles in the nanometer range.

The production of droplets and vesicles has found use in many industrial, medical, and research applications. Often, functional microparticles are prepared from the droplets that serve as e.g. delivery vehicles for drugs or cosmetics, advantageously with a slow release functionality.

However, by virtue of its small feature sizes, microfluidic droplet generation has been limited to low volumetric throughputs (typically less than 1 mL/hr), which provides a challenge for those who pursue high-throughput commercial applications.

Attempts have been made to integrate a plurality of droplet generators into a single chip (a so-called multichannel chip), but this has not yet resulted in a process with a sufficiently high throughput in combination with uniform droplet formation. This is in part due to insufficient control over flow rates of liquids in the microfluidic chip. In particular, flow rates are not uniform for the different droplet generators in a chip.

Another problem that is encountered with multichannel chips is that the start-up of a production run is often troublesome. For unknown reasons, liquid flow does not start in all droplet generators, leaving some of them inactive (dormant) or leading to their (temporary) underperformance. This decreases the product yield and/or product quality of the chip as a whole. Also, the initial presence of gas bubbles causes the problem that different droplet generators are fed with a different flow, which causes more dispersity (less uniformity) in the particles collected from the chip as a whole, in particular less uniform particle dimensions. A solution to solve such start-up problems might involve aborting the production run and starting all over again, which is time-consuming and leads to waste of material. It is also possible to continue with the impaired run and to try to activate the dormant droplet generators. However, any successes obtained in doing so have more to deal with luck than with ratio. No production methods or multichannel chips have been designed that tackle the problem of dormant droplet generators upfront, i.e. which prevent that droplet generators refuse to become active in the first place. Neither have there been successful efforts to minimize the impact of gas bubbles on the product quality.

### SUMMARY OF THE INVENTION

It is therefore an objective of the invention to provide a method and equipment that solves one or more of the above problems.

Therefore, the present invention relates to a microfluidic chip (1) comprising at least two units (2) for droplet formation, each unit (2) comprising
a first supply channel (3) for supplying a first phase, comprising an inlet opening (3a) for the inlet of the first phase;
a second supply channel (4) for supplying a second phase, comprising an inlet opening (4a) for the inlet of the second phase;
a discharge channel (5) for discharging a product phase, comprising an outlet opening (5a) for the outlet of the product phase;

wherein
the first and second supply channel (3, 4) converge at a junction (6) to the discharge channel (5);
the first supply channel (3) has a hydraulic resistance Rₛ₁ and along at least part of the supply channel (3) a minimal cross-sectional surface area MSAₛ₁;
the second supply channel (4) has a hydraulic resistance Rₛ₂ and along at least part of the supply channel (4) a minimal cross-sectional surface area MSA_{S2};
the discharge channel (5) has a hydraulic resistance R_{d} and along at least part of the discharge channel (5) a minimal cross-sectional surface area MSA_{d};

wherein the microfluidic chip (1) comprises
a first manifold (11) for simultaneously supplying the first phase to the first supply channels (3) of the units (2);
a second manifold (12) for simultaneously supplying the second phase to the second supply channels (4) of the units (2); and

wherein Rₛ₁≥2×R_{d} and/or Rₛ₂≥2×R_{d}.

Herebelow, the terms ‘inlet opening’ and ‘outlet opening’ are for simplicity reduced to ‘inlet’ and ‘outlet’, respectively.

The present invention further relates to a cartridge (15) comprising a microfluidic chip (1) as described above, the cartridge (15) comprising
a first opening coinciding with a first manifold inlet (11a) for supplying the first phase to the first manifold (11) of the microfluidic chip (1);
a second opening coinciding with a second manifold inlet (12a) for supplying the second phase to the second manifold (12) of the microfluidic chip (1);
a third opening coinciding with a manifold outlet (13a) for collecting the product phase from the microfluidic chip (1);

wherein
the units (2) are arranged in such manner that they lie in the same plane or define a curved surface, in particular in such manner that the discharge channels (5) lie in the same plane or define a curved surface;
all of the manifold inlets (11a, 12a) and all of the manifold outlets (13a) are on the same side of the plane or the curved surface.

The present invention further relates to an assembly (16) comprising a cartridge (15) as described above and a camera (20) positioned to record that side of the microfluidic chip (1) in the cartridge (15) that is opposite to the side comprising the manifold inlets and the manifold outlet, wherein the channels in the microfluidic chip (1) are visible and/or recordable by the camera through a transparent plate.

The present invention further relates to an assembly (21) comprising a cartridge (15) as described above and a source of electromagnetic radiation to illuminate that side of the microfluidic chip (1) in the cartridge (15) that is opposite to the side comprising the manifold inlets and the manifold outlet, wherein the radiation is capable of reaching an inner volume in at least the discharge channels (5) through a plate (19) that is transparent to the electromagnetic radiation used for the illumination.

The present invention further relates to system for forming droplets, comprising
a first fluid supply system for supplying the first phase to the first manifold of the microfluidic chip (1) as described above;
a second fluid supply system for supplying the second phase to the second manifold of the microfluidic chip (1) as described above;
one or more microfluidic components, which one or more microfluidic components are
   one or more microfluidic chips (1) as described above; or
   one or more a cartridges (15) as described above; or
   one or more an assemblies (16, 21) as described above;
wherein the first fluid supply system and the second fluid supply system are fluidly connected to the one or more microfluidic components.

The present invention further relates to a method for the manufacture of droplets, vesicles, microparticles or nanoparticles, comprising the use of a microfluidic chip (1) as described above, a cartridge (15) as described above or an assembly (16, 21) as described above, wherein
a disperse phase is fed through the first channel (3);
a continuous phase is fed through the second channel (4);
   so that a product phase comprising droplets, vesicles, microparticles or nanoparticles is generated in the discharge channel (5) and collected after it is discharged through the discharge channel (5).

### BRIEF DESCRIPTION OF THE DRAWINGS

FIG. 1 displays a top view of a first microfluidic chip according to the invention.

FIG. 2 displays a first, a second, a third and a fourth unit for droplet formation in a microfluidic chip according to the invention.

FIG. 3 displays a top view of a second microfluidic chip according to the invention.

FIG. 4 displays a fifth unit for droplet formation in a microfluidic chip according to the invention.

FIG. 5 displays a top view of a third microfluidic chip according to the invention.

FIG. 6 displays a top view of a fourth microfluidic chip according to the invention,

FIG. 7 displays a side view of a fifth microfluidic chip according to the invention.

FIG. 8 displays a side view of a cartridge according to the invention.

FIG. 9 displays a side view of an assembly according to the invention.

FIG. 10 displays five micrographs of five discharge channels of a conventional microfluidic chip that is in operation.

FIG. 11 displays a micrograph of a microfluidic chip according to the invention that is in operation.

FIG. 12 shows the particle size distribution of droplets that are obtained with a microfluidic chip of the invention.

FIG. 13 is a micrograph of droplets that are obtained with a microfluidic chip of the invention.

### DETAILED DESCRIPTION OF THE INVENTION

Elements in the figures are illustrated for simplicity and clarity and have not necessarily been drawn to scale. For example, the dimensions of some of the elements in the figures may be exaggerated relative to other elements to help improve understanding of various exemplary embodiments of the present invention. In particular, the relative lengths and diameters of the different channels cannot be derived from the figures, neither can the relative hydraulic resistances of the different channels. Furthermore, the terms “first”, “second”, and the like herein, if any, are generally used for distinguishing between similar elements and not necessarily for describing a sequential or chronological order.

In the context of the invention, by the term “disperse phase” is meant a phase comprising a compound or a composition of compounds that is intended to pass the unit for droplet formation in a microfluidic chip of the invention to yield a dispersion wherein the disperse phase has become dispersed in the continuous phase. The disperse phase itself is typically not dispersed prior to passing the junction—and thus typically not a dispersion. It is usually homogeneous, for example a solution, a liquid or a mixture of liquids. In particular instances, however, the disperse phase can be a phase comprising a dispersion or a suspension.

In the context of the invention, by the term “continuous phase” is meant a phase comprising a compound or a composition of compounds that is intended to pass the unit for droplet formation in a microfluidic chip of the invention to yield a dispersion wherein the continuous phase forms the dispersion medium for the disperse phase. The continuous phase is usually homogeneous, for example a solution, a liquid or a mixture of liquids.

In the context of the invention, by the term “unit for droplet formation” is meant a unit that is suitable for forming droplets, including nanodroplets and microdroplets. Such unit is also suitable for forming other types of entities, e.g. vesicles, microparticles or nanoparticles. For reasons of clarity, however, it is not constantly stated that the formation of other entities such as nanodroplets and microdroplets is also included. A person skilled in the art knows how to select the different phases and their flow conditions so as to generate the desired type of entity. The term “unit for droplet formation” is equivalent to the term “droplet generator”, which is also used throughout the text herebelow.

In general, droplet formation in microfluidic chips occurs at the location where a channel that supplies a first phase ends up in another channel that supplies a second phase. Usually, this location is at the junction of the two channels, but it may also be downstream of the junction when one channel extends downstream in the other channel over a particular length. One phase is usually formed by a continuous phase and the other phase by a disperse phase. After the droplet formation, a product phase comprising the droplets moves through a discharge channel that is also part of the junction. In the product phase, the continuous phase is the phase that surrounds the droplets that are formed from the disperse phase.

In a microfluidic chip of the invention, a first supply channel, a second supply channel and a discharge channel, all three fluidly connected to one another by means of a junction, form part of a unit for droplet formation. At the junction, the supply channels combine and merge to form the discharge channel. Each supply channel has an inlet and the discharge channel has an outlet. During operation, the first supply channel supplies a first phase (e.g. a disperse phase), the second supply channel supplies a second phase (e.g. a continuous phase) and the discharge channel discharges a product phase (typically an emulsion of both phases comprising droplets). The flow direction in the supply channels is from the inlet towards the junction, and the flow direction in the discharge channel is away from the junction towards the outlet. In this manner, an emulsion comprising the actual droplets may continuously be prepared in the unit from the two supply feeds.

The channels converge at the junction at a particular angle. The angle between a supply channel and the discharge channel may in principle be any angle. It is preferred however that the angle is between 90° and 180° (including the values 90° and 180°), wherein the angle is the smallest angle between the respective supply channel and the discharge channel in the flow direction (when the angle between two channels is 90°, then the channels are perpendicular; when the angle between two channels is 180°, then both channels (and the flow therein) have the same direction—flow continues without changing direction). The angle may also be in the range of 125°-145°, in the range of 140°-170° or in the range of 100°-130°.

The pathways that are travelled by the liquids through the unit concern either the first supply channel followed by the discharge channel or the second supply channel followed by the discharge channel. In accordance with the invention, in at least one of these pathways the supply channel has a hydraulic resistance Rₛ that is at least twice the hydraulic resistance R_{d} of the discharge channel (i.e. Rₛ≥2×R_{d}). In other words, in at least one pathway for the transport of liquid material, the hydraulic resistance ratio Rₛ/R_{d} is 2 or more.

More specifically, the hydraulic resistance (Rₛ₁) of the first supply channel is at least twice the hydraulic resistance (R_{d}) of the discharge channel (i.e. Rₛ₁≥2×R_{d}) and/or the hydraulic resistance (Rₛ₂) of the second supply channel is at least twice the hydraulic resistance (R_{d}) of the discharge channel (i.e. Rₛ₂≥2×R_{d}).

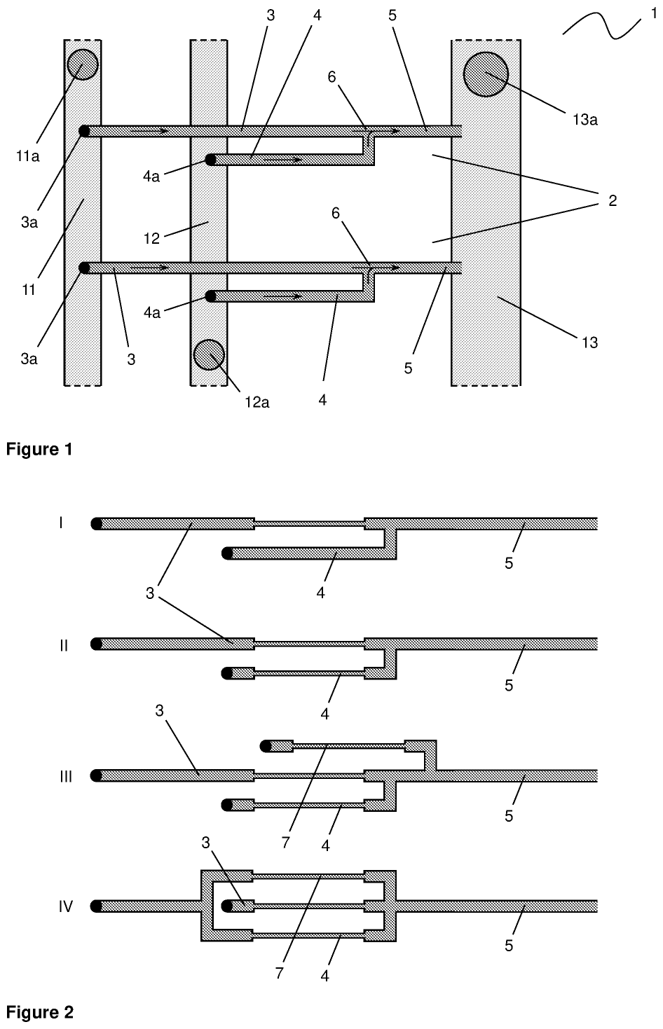

FIG. 1 displays a microfluidic chip (1) of the invention comprising two units (2) for droplet formation. Each unit (2) comprises a first supply channel (3), a second supply channel (4) and a discharge channel (5). All of these channels (4, 5, 6) are connected to one another at a junction (6); all have one end that participates in the junction. The other end of the first supply channel (3) comprises an inlet (3a), the other end of the second supply channel (4) comprises an inlet (4a) and the other end of the discharge channel (5) comprises an outlet (5a). The two first inlets (3a) of the two units (2) are both connected to a first manifold (11) which supplies the first phase. The two second inlets (4a) of the two units (2) are both connected to another, second, manifold (12) which supplies the second phase. The first manifold (11) comprises a first manifold inlet (11a) for supplying the first phase to the first manifold (11) and ultimately to all units (2) of the chip (1). The second manifold (12) comprises a second manifold inlet (12a) for supplying the second phase to the second manifold (12) and ultimately to all units (2) of the chip (1). Thus, each manifold inlet (11a, 12a) provides the supply of a particular phase to the entire chip (1), i.e. to all units (2) for droplet formation. The two outlets (5a) of the discharge channel (5) are connected to a manifold (13) comprising a manifold outlet (13a) for collecting the product phase from the chip (1).

All channels in FIG. 1 have a constant diameter along their entire length (or, more generally, each channel has a cross-sectional shape that does not vary over its length). However, the drawings are not drawn to scale, in particular in the sense that a comparison between the diameters of different channels cannot be made. Therefore, the relative hydraulic resistances of the different channels cannot be derived from the drawings. As a result, it can neither be derived from FIG. 1 whether the requirement Rₛ≥2×R_{d} applies to one or both supply channels. In general, this accounts for all of the Figures displaying microfluidic chips and/or units for microdroplet formation.

FIG. 2 displays four variations of the units (2) for droplet formation. These are drawn as separate structures which, for reasons of clarity, are not positioned on a chip and lack elements such as the manifolds, the manifold inlets and the manifold outlet(s).

The first variation (I) is a unit (2) with the two supply channels (3, 4) wherein one supply channel (3) has a narrowed section while the other supply channel (4) has not. Both supply channels (3, 4) converge into the discharge channel (5).

The second variation (II) is a unit (2) with the two supply channels (3, 4) wherein both supply channels (3, 4) have a narrowed section. Both supply channels (3, 4) converge into the discharge channel (5).

The third variation (III) is a unit (2) wherein there is a third supply channel (7) in addition to the two supply channels (3, 4), which all three have a narrowed section. This variation allows the supply of three different phases in the three supply channels (3, 4, 7). Both supply channels (3, 4) converge into the discharge channel (5) and the third supply channel (7) combines at another location of the discharge channel (5), so this unit (2) comprises two junctions.

The fourth variation (IV) is also a unit (2) with three supply channels (3, 4, 7) which all three have a narrowed section. All three supply channels (3, 4, 7) converge into the discharge channel (5). This variation however provides the supply of only two different phases in the three supply channels. This follows from the presence of only two supply inlets; the channel of one of the inlets splits into the two channels (4, 7), a structure reminiscent of a fork. The two channels (4, 7) converge again downstream at the junction.

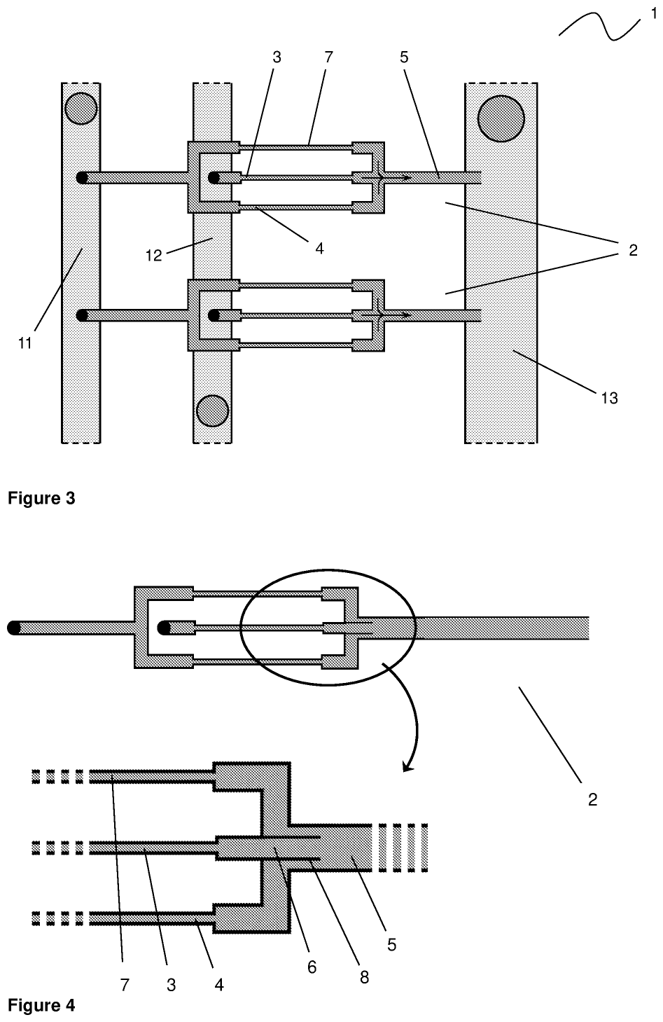

FIG. 3 is a variation of the microfluidic chip (1) of FIG. 1 in that its units (2) for droplet formation are of the type of variation (IV) of FIG. 2.

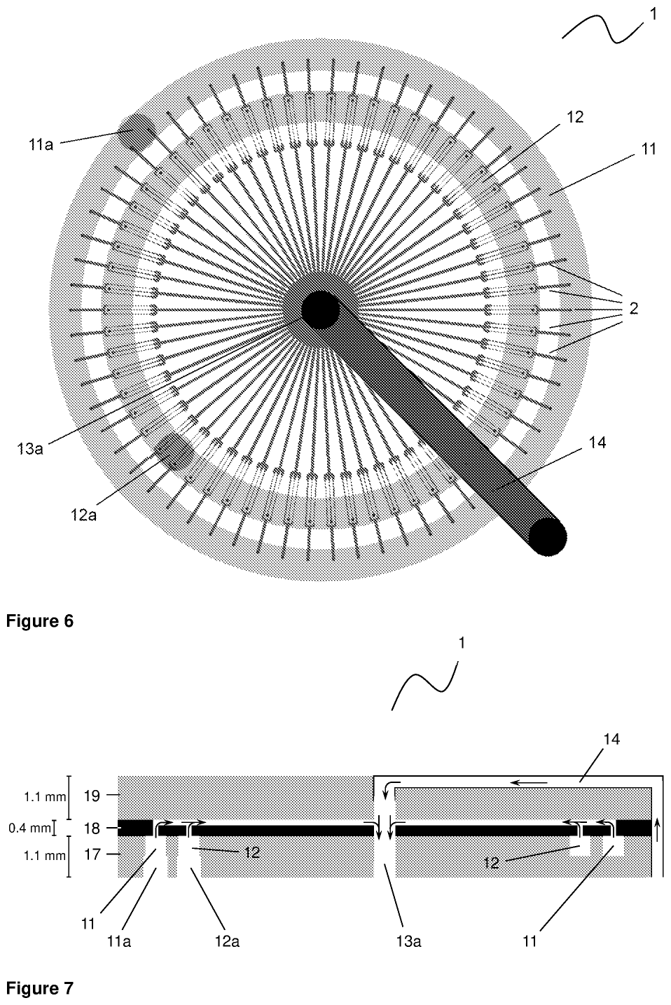

Also the microfluidic chips (1) displayed in FIGS. 5 and 6 comprise units (2) of the type of variation (IV) of FIG. 2.

The hydraulic resistance is the resistance to flow that is experienced by a liquid flow through a channel (or other hydraulic component such as a pipe, a tube, a valve, etc.). It is dependent on variables such as the viscosity of the liquid and the dimensions of the channel (in particular its cross-section and its length). For example, for a channel with a rectangular cross-section, the expression for the hydraulic resistance Rₕ is:

Rₕ≈12 μL/wh³(1-0.63h/w)

wherein μ is a fluidic viscosity of a particular fluid flowing through the channel, in particular of a liquid, L, w and h are length, width and height of the channel, respectively (the expression is valid when h<w).

When, in the context of the invention, a hydraulic resistance is defined for a certain supply channel, then this means that the hydraulic resistance is defined over the entire length of the supply channel, i.e. from its inlet to the junction.

When, in the context of the invention, a hydraulic resistance is defined for a certain discharge channel, then this means that the hydraulic resistance is defined over the entire length of the discharge channel, i.e. from the junction to its outlet.

When, in the context of the invention, a hydraulic resistance is defined for a certain manifold, then this concerns in principle a part of the manifold where liquid flow passes for the supply of one or more units for droplet formation. Preferably, this is a section that extends from the manifold inlet to a connection of the manifold with a unit for droplet formation that is most distant from the manifold inlet (measured over the manifold).

With the viscosity (μ) of the liquid in the equation, the hydraulic resistance of a channel is a property of that channel for a certain fluid that flows through the channel. This means that a channel does not have a universal value for its hydraulic resistance, but a specific value for each fluid that may flow through the channel. However, when hydraulic resistances of several channels are compared, then the viscosity of the fluid drops out of the equation. This is because, in a microfluidic chip of the invention, the hydraulic resistances of different channels are all based on one and the same fluid that flows through the channels. The present invention requires that Rₛ₁≥2×R_{d} and/or Rₛ₂≥2×R_{d}, which describes a relative resistance to flow of one and the same fluid through the different channels (and it does not matter which fluid, as long as the same fluid is concerned).

Usually, in a unit wherein there is a hydraulic resistance ratio Rₛ/R_{d} of 2 or more, the respective supply channel is more narrow than the discharge channel. More specifically, in such case the respective supply channel has a minimal cross-sectional surface area MSAₛ along at least part of the channel that is smaller than the smallest cross-sectional surface area MSA_{d} anywhere along the discharge channel. More specifically, in such case MSA_{d}≥MSAₛ₁, wherein MSAₛ₁ is the minimal cross-sectional surface area along at least part of the first supply channel and wherein MSA_{d} is the minimal cross-sectional surface area along at least part of the discharge channel. Correspondingly, in such case, usually MSA_{d}≥MSAₛ₂, wherein MSAₛ₂ is the minimal cross-sectional surface area MSAₛ₂ along at least part of the second supply channel. For example, MSA_{d}≥1.5×MSAₛ₁ and/or MSA_{d}≥1.5×MSAₛ₂. In particular, MSA_{d}≥2×MSAₛ₁ and/or MSA_{d}≥2×MSAₛ₂; more in particular MSA_{d}≥10×MSAₛ₁ and/or MSA_{d}≥10×MSAₛ₂; even more in particular MSA_{d}≥20×MSAₛ₁ and/or MSA_{d}≥20×MSAₛ₂. Accordingly, a cross-sectional ratio MSA_{d}/MSAₛ₁ can be defined that is more than 1, that is 1.5 or more, that is 2 or more, that is 10 or more or that is 20 or more; and a cross-sectional ratio MSA_{d}/MSAₛ₂ can be defined that is more than 1, that is 1.5 or more, that is 2 or more, that is 10 or more or that is 20 or more. This contributes to the feature of the invention that the hydraulic resistance in the supply channel is higher than the hydraulic resistance in the discharge channel. Moreover, the higher the cross-sectional ratio, the higher the contribution.

It is however not necessary that the supply channel is more narrow than the discharge channel; it may also have the same cross-sectional surface area as the discharge channel, or even a higher cross-sectional surface area. In such cases, the higher hydraulic resistance in the supply channel is typically achieved by increasing the length of the supply channel. A microfluidic chip with units (2) for droplet formation wherein all channels have the same cross-sectional surface area is for example displayed in FIG. 1.

A preferred design in case MSAₛ<MSA_{d} is a design wherein
the first supply channel comprises a narrowed section of a particular length, wherein the cross-sectional surface area of the narrowed section corresponds to MSAₛ₁; and
the discharge channel has a constant cross-sectional surface area that corresponds to MSA_{d}.

A section of the first supply channel in such design that is not narrowed may then have a cross-sectional surface area that corresponds to that of the discharge channel (i.e. to MSA_{d}). Units for droplet formation with a design comprising one or more narrowed sections are for example displayed in FIG. 2.

So, liquid material that is supplied to a unit for droplet formation with a structure according to the invention first passes a channel having a high hydraulic resistance (a supply channel) and further downstream a channel having a two or more times lower hydraulic resistance (the discharge channel). At the interface of both channels, the liquid material passes the junction. The formation of the droplets in principle occurs at the junction, or slightly more downstream in the discharge channel.

The hydraulic resistance of the supply channels and the discharge channel can be derived from measured pressure drops over a supply channel and the discharge channel at a plurality of flow rates. Pressure sensors that are located at the inlet of the supply channels and at the outlet of the discharge channel are typically used to measure these pressure drops.

By varying the pressure at the inlet of the supply channels independently of one another, the separate contributions of each supply channel and the discharge channel to the total pressure drop can be determined. Typically, three different combinations of pressures at the first inlet and the second inlet are applied to achieve this.

As noted above, the invention relies on the presence of a hydraulic resistance ratio Rₛ/R_{d} of 2 or more (i.e. Rₛ₁≥2×R_{d} and Rₛ₂≥2×R_{d},). The hydraulic resistance ratio Rₛ/R_{d} may also be 4 or more (i.e. Rₛ₁≥4×R_{d} and/or Rₛ₂≥4×R_{d},), 7 or more (i.e. Rₛ₁≥7×R_{d} and/or Rₛ₂≥7×R_{d},), 10 or more (i.e. Rₛ₁≥10×R_{d} and/or Rₛ₂≥10×R_{d},), 15 or more (i.e. Rₛ₁≥15×R_{d} and/or Rₛ₂≥15×R_{d},), 20 or more (i.e. Rₛ₁≥20×R_{d} and/or Rₛ₂≥20×R_{d},), 30 or more (i.e. Rₛ₁≥30×R_{d} and/or Rₛ₂≥30×R_{d},), 40 or more (i.e. Rₛ₁≥40×R_{d} and/or Rₛ₂≥40×R_{d},), 50 or more (i.e. Rₛ₁≥50×R_{d} and/or Rₛ₂≥50×R_{d},), 75 or more (i.e. Rₛ₁≥75×R_{d} and/or Rₛ₂≥75×R_{d},), 100 or more (i.e. Rₛ₁≥100×R_{d} and/or Rₛ₂≥100×R_{d},), 250 or more (i.e. Rₛ₁≥250×R_{d} and/or Rₛ₂≥250×R_{d},), 500 or more (i.e. Rₛ₁≥500×R_{d} and/or Rₛ₂≥500×R_{d},) or 1,000 or more (i.e. Rₛ₁≥1,000×R_{d} and/or Rₛ₂≥1,000×R_{d},).

Actually, the cross-sectional ratio is preferably as high as possible, although limits thereto are imposed by the design possibilities. For example, a low hydraulic resistance R_{d} can be obtained by either an exceptionally short discharge channel or by an exceptionally wide discharge channel (or by a combination of both). However, a certain channel length is required to allow for a stable droplet formation—a too short channel would have a negative influence on droplet formation. Also, increasing the width of the discharge channel would result in unstable droplets.

Further, it is considered optional that the minimal cross-sectional ratio MSA_{d}/MSAₛ is more than 1, for example 1.5 or more, or 2 or more. Since the cross-sectional surface area may vary over the length of a section, the definition of the minimal cross-sectional surface area of the supply channel is based on the lowest cross-sectional surface area that is present somewhere along the supply channel and the definition of the minimal cross-sectional surface area of the discharge channel is based on the lowest cross-sectional surface area that is present somewhere along the discharge channel.

When both surface areas differ, the cross-sectional ratio MSA_{d}/MSAₛ may be 1.5 or more (i.e. MSA_{d}≥1.5×MSAₛ), 2 or more (i.e. MSA_{d}≥2×MSAₛ), 4 or more (i.e. MSA_{d}≥4×MSAₛ), 10 or more (i.e. MSA_{d}≥10×MSAₛ), 20 or more (i.e. MSA_{d}≥20×MSAₛ), 50 or more (i.e. MSA_{d}≥50×MSAₛ) or 100 or more (i.e. MSA_{d}≥100×MSAₛ).

In an embodiment, MSAₛ₁ and MSAₛ₂ are independently of one another in the range of 10-10,000 μm² and/or MSA_{d} is in the range of 25-250,000 μm². In another embodiment, MSAₛ₁ and MSAₛ₂ are in the range of 50-5,000 μm² and/or MSA_{d} is in the range of 500-100,000 μm². In yet another embodiment, MSAₛ₁ and MSAₛ₂ are in the range of 100-1,000 μm² and/or MSA_{d} is in the range of 250-2,500 μm².

In a microfluidic chip according to the invention, it may be that MSA_{d}≥2×MSAₛ₁ and MSA_{d}≥2×MSAₛ₂ and Rₛ₁≥10×R_{d}. In particular, it may be that MSA_{d}≥5×MSAₛ₁ and MSA_{d}≥5×MSAₛ₂ and Rₛ₁≥20×R_{d}. More in particular, it may be that MSA_{d}≥10×MSAₛ₁ and MSA_{d}≥10×MSAₛ₂ and Rₛ₁≥40×R_{d}.

Generally, flow rates in channels of a microfluidic chip affect the properties of the generated droplets. Any disturbances or non-uniformities in flow rates may result in a decreased product quality, in particular in a decrease of droplet uniformity, for example the uniformity of the size of droplets.

The effect of a channel with a high hydraulic resistance through which liquid passes prior to arriving at the junction, is that there is a better controlled flow rate of the liquid material at the junction, i.e. at the location where droplets are formed. As a result, the conditions at the junctions are uniform over the entire chip, allowing the chip to produce droplets that have a highly uniform size. This is an advantage of a microfluidic chip of the invention, which has not been achieved by conventional multichannel chips.

In a microfluidic chip of the invention, there are at least two supply channels for liquid transport. Since every supply channel in the chip is part of a different pathway for liquid transport through the chip, a chip of the invention comprises at least two of such pathways. In at least one of these pathways, Rₛ≥2×R_{d} (e.g. Rₛ₁≥2×R_{d} or Rₛ₂≥2×R_{d}). Preferably, however, both pathways obey the formula Rₛ≥2×R_{d} (i.e. Rₛ₁≥2×R_{d} and Rₛ₂≥2×R_{d}). FIG. 1 displays a microfluidic chip with units that have two pathways, wherein one or both pathways obey the formula Rₛ≥2×R_{d}.

Further, in case a unit has three supply channels that are all in fluid communication with the discharge channel, and thus three pathways for liquid transport, it is preferred that all three pathways obey the formula Rₛ≥2×R_{d} (i.e. Rₛ₁>2×R_{d} and Rₛ₂≥2×R_{d} and Rₛ₃≥2×R_{d}). FIG. 3 displays a microfluidic chip with units that have three pathways, at least one of them obeying the formula Rₛ≥2×R_{d}.

Also, in case of 4 or 5 supply channels, all 4 or 5 pathways obey the formula Rₛ≥2×R_{d}.

As described above, a unit for droplet formation in a microfluidic chip according to the invention may comprise more than two supply channels. Such further supply channel(s) may concern a third, a fourth, a fifth or even further supply channel. A further supply channel may join (converge) at the junction or at another position of the discharge channel. Such further channel may be a redundant supplier of another phase. For example, a third supply channel may supply the first phase or the second phase, so that there are only two channels to actually supply a different phase. Typically, two different channels that supply the same phase in a unit are merging at opposing sides of the junction. This offers particular advantages in the droplet generation. On the other hand, a third channel may also supply a third phase and converge at a second junction more downstream, for example for the preparation of double emulsions.

Accordingly, the units in a microfluidic chip of the invention may comprise a third supply channel for redundantly supplying the first phase, for redundantly supplying the second phase or for supplying a third phase, wherein
the third supply channel converges at a junction to the discharge channel;
the third supply channel has a hydraulic resistance Rₛ₃ and along at least part of the supply channel a minimal cross-sectional surface area MSAₛ₃;
wherein one or more hydraulic resistances selected from the group of Rₛ₁, Rₛ₂ and Rₛ₃ are at least 2 times the hydraulic resistance R_{d}.

FIG. 3 displays a microfluidic chip (1) according to the invention comprising a unit with three supply channels (3, 4, 7).

A microfluidic chip according to the invention may have units for droplet formation wherein one of the supply channels protrudes from the junction into the discharge channel with a protruding channel portion. This means that it is not the end of the supply channel that converges with the other supply channel and the discharge channel, but that it is an intermediate portion of the channel near the end of the channel. The result is a channel in a channel (i.e. the supply channel in the discharge channel), allowing droplet or particle formation in two streams that flow in parallel. In the context of the invention, the portion of the channel that is protruding into the discharge channel is the protruding channel portion. The length of the protruding channel portion may be as long as its width. It may also be 1-10 times its width, 2-8 times its width or 3-5 times its width.

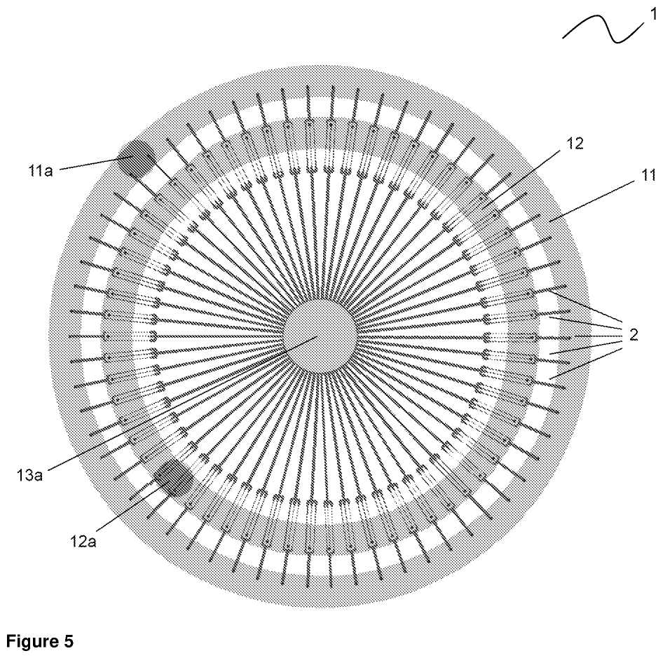

FIG. 4 displays a microfluidic chip (1) according to the invention comprising such a unit (2). It comprises a protruding channel portion (8).

A microfluidic chip according to the invention comprises at least 2 of the units for droplet formation. Preferably, however, the chip comprises more than two units, for example at least 5 units, at least 10 units, at least 25 units, at least 50 units, at least 75 units, at least 100 units or at least 150 units. With a small number of units (such as 2-10) as well as with a large number of units (such as 150 or more), excellent flow properties can be achieved in each unit of a chip of the invention, yielding uniform microdroplets. Further, also during the initial filling of the chip with the appropriate phases, all channels of a particular type display the same behavior and no units or channels end up in a dormant state.

The different units are typically designed and arranged in such manner that they lie in the same plane, in particular that at least a certain type of channels lie in the same plane or define a curved surface, for example with the discharge channels in the same plane or at the same curved surface. In view of the manufacturing process of the microfluidic chips of the invention, it is preferred that all units lie in the same plane, since this allows the etching of the channels in a flat substrate, followed by covering the substrate with a flat plate such as a glass plate.

The units for droplet formation are fluidly connected to two manifolds which are typically integrated in the chip. A manifold is designed to supply a particular phase to all of the connected units for droplet formation; or to discharge a product phase from all of the connected units for droplet formation. The first manifold is typically connected to the first inlets of the first supply channels of the units for droplet formation by fluid connections. This means that a plurality of such connections is present along the first manifold. Correspondingly, the second manifold is typically connected to the second inlets of the second supply channels of the units for droplet formation by fluid connections. This means that a plurality of such connections is present along the second manifold. The number of inlets of the supply channels that is connected to a particular manifold is usually equal to the number of units for droplet formation that is present in the microfluidic chip. The fluid connection of an inlet of a supply channel to a manifold usually essentially coincides with the inlet itself.

A manifold may be a straight or circular channel wherein the supplied liquid can flow on either side of a manifold inlet. It is also possible that a manifold inlet is present at an end of the manifold, so that a liquid can only flow in one direction.

A manifold is optionally used to discharge a product formed in a chip of the invention. Such manifold is then fluidly connected to the discharge channels of the chip.

In a microfluidic chip of the invention, there is one manifold for each of the two supply phases. Accordingly, such chip comprises at least two manifolds. In case such chip is designed to supply additional phases, such as a third phase or a fourth phase, it is preferred that corresponding additional manifolds each supply a particular additional phase. Optionally, a manifold is present to collect a product phase from all connected units.

When a chip of the invention is in operation, the two manifolds themselves are supplied with a fluid by an external fluid supply system, which typically comprises a reservoir of a particular liquid phase that is to be fed through the chip and a pumping means for pumping the liquid phase into the microfluidic chip via a manifold inlet. This occurs via a minimal number of inlets to the manifolds, so that as few as possible connections between a fluid supply system and a chip have to be made. Therefore, each manifold for fluid supply preferably has only one manifold inlet. In the context of the invention, such inlet is equivalent to a ‘chip inlet’. This reflects the function of such manifold: receiving an external liquid supply that is destined for all the units in the chip, followed by dividing this supply over the units. Accordingly, the first manifold typically comprises a first manifold inlet for supplying the first phase to the first manifold and ultimately to all units of the chip; and the second manifold typically comprises a second manifold inlet for supplying the second phase to the second manifold and ultimately to all units of the microfluidic chip.

Correspondingly, when a chip of the invention comprises a manifold for fluid discharge (i.e. of the product phase), then it has a manifold outlet. (preferably, such manifold comprises one manifold outlet). In the context of the invention, such outlet is equivalent to a ‘chip outlet’. This reflects the function of such manifold: receiving the product phases from the discharge channels of the connected units for droplet formation and combining them, followed by a release thereof from the microfluidic chip.

A chip with such three manifolds is for example demonstrated in FIG. 1, wherein two manifolds (11, 12) each supply a different phase to the two units (2) and one manifold (13) collects the product from the two units (2). Each of the two supply manifolds (11, 12) comprises a manifold inlet (11a, 12a) and the production collection manifold (13a) comprises a manifold outlet (13a).

In FIG. 5, two manifolds (11, 12) each supply a different phase to 62 units (2). Due to the circular nature of the chip (1) of FIG. 5, there is no corresponding manifold for product collection, as is further elaborated below.

In a chip design wherein the units are arranged in the same plane, the manifold is typically a channel that runs parallel to the plane and so crosses the plurality of supply channels. The connection between the manifold and a channel is then typically formed by a short channel that extends out of the plane formed by the units, preferably by a channel that is perpendicular to the plane.

In case the units are arranged in a radial manner, a manifold connecting the inlets of the units is typically in the shape of a circle. When the discharge channels are arranged with their outlets directed towards the radial center, then the product phase of all discharge channels can be collected in a hole (rather than in a manifold) that is present at the radial center—the outlets of all discharge channels then converge into the hole. This configuration is displayed in FIGS. 5 and 6.

In a preferred embodiment, a chip of the invention is a chip
wherein
   the first manifold (11) comprises a first manifold inlet (11a) for the inlet of the first phase;
   the first inlets (3a) of the first supply channels (3) are connected to the first manifold (11) by fluid connections that are present along the first manifold; and
   a hydraulic resistance Rₘ₁ to flow of the particular fluid is defined for a first section of the first manifold (11), the first section extending from the first manifold inlet (11a) to a most remote fluid connection that is most remote from the first manifold inlet (11a), measured along the first manifold (11);
wherein
   the second manifold (12) comprises a second manifold inlet (12a) for the inlet of the second phase;
   the second inlets (4a) of the second supply channels (4) are connected to the second manifold (12) by fluid connections that are present along the second manifold;
   a hydraulic resistance Rₘ₂ to flow of the particular fluid is defined for a second section of the second manifold (12), the second section extending from the second manifold inlet (12a) to a most remote fluid connection that is most remote from the second manifold inlet (12a), measured along the second manifold (12); and
wherein Rₛ₁≥10×Rₘ₁ and Rₛ₂≥10×Rₘ₂.

When such a first or second manifold delivers a liquid to a particular supply channel, then the pressure of the liquid downstream of the connection to the particular supply channel is slightly decreased. Such a decrease occurs after each connection with a supply channel. It is important that liquid flow in the last supply channel (i.e. the one that is most remote from the manifold inlet) is not affected by the reduced pressure. This is accomplished by designing the manifold in such way that the hydraulic resistance in the manifold, from the inlet to the last supply channel, is at least ten times lower than that of the supply channel itself. This means that Rₛ₁≥10×Rₘ₁ and Rₛ₂≥10×Rₘ₂, wherein Rₘ₁ and Rₘ₂ are the hydraulic resistances to flow of the particular fluid in a section of the respective manifold. The section is defined as the part of the manifold that extends from the manifold inlet to the supply channel that is most remote from the manifold inlet, measured along the manifold.

In this way, the hydraulic resistance of the manifold in principle does not play a role in operating the chip and does not have an influence on the flow behavior in the chip. Usually, this is performed by increasing the cross-sectional surface area of the manifold, wherein SAₘ₁ is the cross-sectional surface area of the first manifold and SAₘ₂ is the cross-sectional surface area of the second manifold. A person skilled in the art knows how to arrive at a manifold wherein Rₛ₁≥10×Rₘ₁ and Rₛ₂≥10×Rₘ₂, by performing routine experimentation and without exerting an inventive effort.

When a manifold is a circular channel wherein the supplied liquid can flow on either side of a manifold inlet (as in e.g. FIG. 5), then the manifold can be thought of as two manifolds of the same length that merge halfway the circular channel, measured from the manifold inlet. The circular manifold can then be regarded as being divided into two halves. Each of the two halves then has one supply channel that is most remote from the manifold inlet, or both halves may share one supply channel that is most remote from the manifold inlet.

In the above embodiment (i.e. wherein Rₛ₁≥10×Rₘ₁ and Rₛ₂≥10×Rₘ₂), the low hydraulic resistance is in the manifold and not in the supply channels of the units for droplet formation that are connected to the manifold. This means that there is one shared area of low hydraulic resistance (serial, i.e. in the manifold) and not a plurality of areas of low hydraulic resistance (parallel, i.e. in all the supply channels of the units for droplet formation.

In a microfluidic chip according to the invention, the hydraulic resistances of the manifolds and the supply channels may also occurs in other ratios. For example, Rₛ₁≥15×Rₘ₁ and Rₛ₂≥15×Rₘ₂; or Rₛ₁≥20×Rₘ₁ and Rₛ₂≥20×Rₘ₂; or Rₛ₁≥30×Rₘ₁ and Rₛ₂≥30×Rₘ₂; or Rₛ₁≥40×Rₘ₁ and Rₛ₂≥40×Rₘ₂; or Rₛ₁≥50×Rₘ₁ and Rₛ₂≥50×Rₘ₂.

In a microfluidic chip according to the invention, it may also be that
Rₛ₁≥10×R_{d}; and
Rₛ₂≥10×R_{d}; and
Rₛ₁≥10×Rₘ₁; and
Rₛ₂≥10×Rₘ₂.

In particular, it may be that
Rₛ₁≥20×R_{d}; and
Rₛ₂≥20×R_{d}; and
Rₛ₁≥20×Rₘ₂; and
Rₛ₂≥20×Rₘ₂.

more in particular, it may be that
Rₛ₁≥40×R_{d}; and
Rₛ₂≥40×R_{d}; and
Rₛ₁≥40×Rₘ₁; and
Rₛ₂≥40×Rₘ₂.

In a chip of the invention, SAₘ₁ and SAₘ₂ are, independently of one another, typically in the range of 2,500-50,000,000 μm² and/or MSAₛ₁ and MSAₛ₂ are, independently of one another, typically in the range of 10-10,000 μm². The SAₘ₁ and SAₘ₂ may, independently of one another, also be in the range of 10,000-10,000,000 μm², in particular in the range of 20,000-5,000,000 μm², more in particular in the range of 50,000-2,000,000 μm², and even more in particular in the range of 100,000-1,000,000 μm².

Thus, with Rₛ₁≥10×Rₘ₁ and Rₛ₂≥10×Rₘ₂, there is essentially no pressure drop in the manifold between the manifold inlet and the plurality of supply channels that are fluidly connected to the manifold. This, on its turn, provides uniform flow rates in all of the different units for droplet formation, and ultimately a highly uniform droplet formation. So, the sequence of
1) a low hydraulic resistance in the manifolds (so that the low hydraulic resistance is in the manifold and not in the supply channels);
2) a high hydraulic resistance in one or both supply channels;
3) a low hydraulic resistance in the discharge channel

provides a high degree of control over flow rates of liquids in the microfluidic chip, which is a prerequisite for preparing uniform droplets in the units for droplet generation.

This cannot be performed by a conventional multichannel chip, which is known to suffer from bad flow control in the different droplet generators that are integrated in them. More specifically, in these chips the flow rates in the units for droplet formation are different in different units, and this results in a poor overall droplet uniformity, in particular a poor uniformity in droplet size. This is because uniformity in droplet size can only be reached on the level of individual units (provided that the flow in each unit is constant). The droplet size itself, however, often varies from unit to unit. In the combined product of all units (i.e. the product that is obtained from the multichannel chip as a whole), the size of droplets is then not uniform.

The invention has overcome this problem by the implementation of the abovementioned sequence of ‘low hydraulic resistance—high hydraulic resistance-low resistance’.

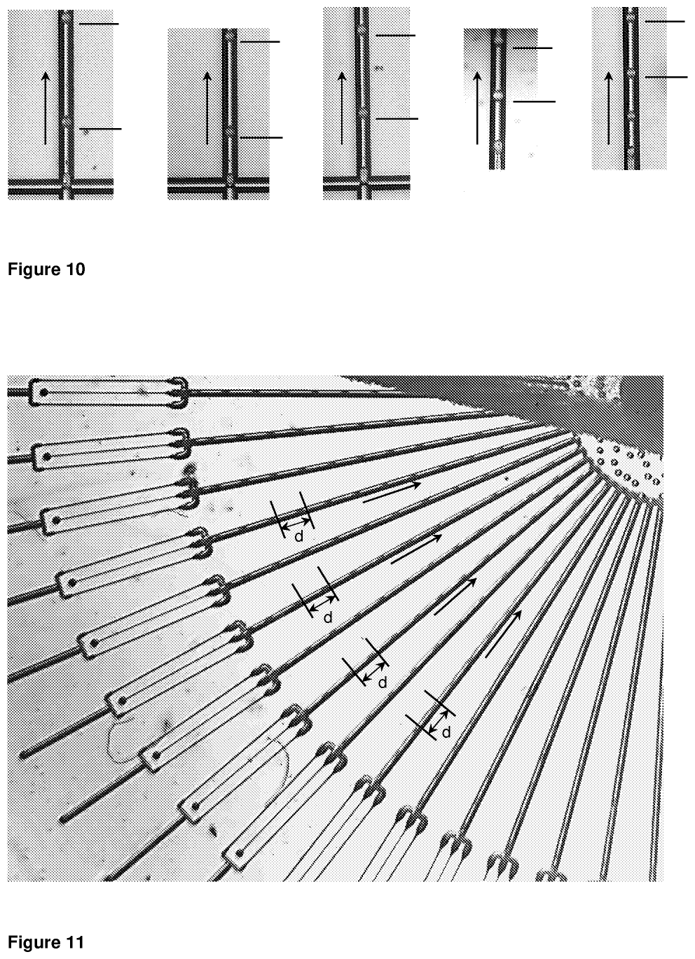

This is illustrated in FIGS. 10 and 11, showing micrographs of microfluidic chips during operation wherein microdroplets are formed and transported through the different discharge channels. FIG. 10 displays five close-ups of five discharge channels of a conventional microfluidic chip comprising multiple parallel units for droplet formation, wherein the flow occurs in the direction of the arrows on the left of each micrograph. FIG. 11 displays a chip according to the invention, wherein the flow direction in the discharge channels is also indicated with arrows. It is evident from these Figures that the flow in the discharge channels of the conventional chip comprises droplets of different sizes and different mutual spacing along the discharge channel. The discharge channels of the chip of the invention, however, contain droplets of a uniform size and a uniform mutual spacing.

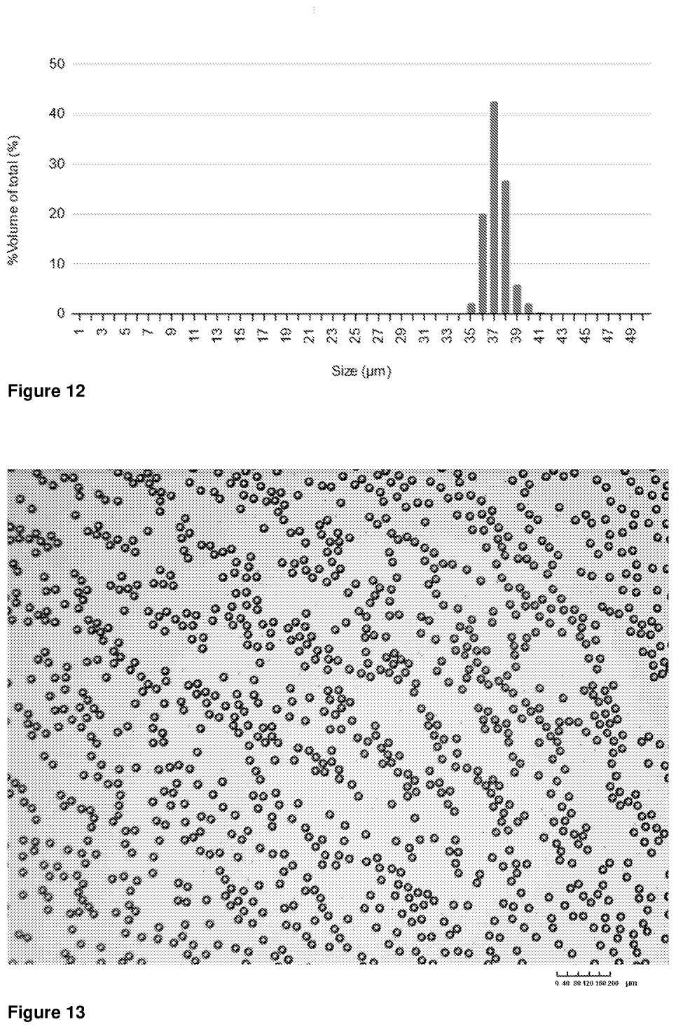

Further, FIGS. 12 and 13 demonstrate the beneficial effects of the chip of the invention on the droplets. FIG. 12 shows the particle size distribution of droplets that are obtained with a microfluidic chip of the invention (P₂₅=36.39 μm; P₅₀=37.07 μm; and P₇₅=37.74 μm). FIG. 13 is a micrograph of these droplets, which demonstrates the uniformity of the droplets.

In order to yield the results displayed in FIGS. 10-13, the conventional microfluidic chip and the microfluidic chip of the invention were operated in the following way. A 5 wt. % PLGA solution in dichloromethane was used as a disperse phase and a 0.1 wt. % PVA solution in water was used as continuous phase. The conventional chip was used with 9 channels in parallel and a flow speed of in total 76 mL/h and 7 mL/h for continuous phase and disperse phase, respectively. The chip of the invention was fed with 525 mL/h of continuous phase and 50 mL/h of disperse phase.

Besides maintaining a robust steady state in the unit (in particular a constant and well-controlled flow rate at the junction), the structure of the unit also offers important advantages during the start-up process of forming droplets, i.e. advantages for actually reaching the steady state. With conventional microfluidic chips having multiple units for droplet formation (multichannel chips), it is not straightforward to start a droplet-formation process with all units displaying the same behavior. For unknown reasons, there are almost always a few channels that refuse to allow sufficient disperse phase flow through the channels (dormant channels). This leads to less productivity of the chip and to product compositions that deviate from what was intended. Surprisingly, this problem is solved by a microfluidic chip of the invention. It was found that when a process is started in a microfluidic chip of the invention, liquid flow typically starts simultaneously in all channels, which is due to the inventive design of the chip. It is contemplated that this has to do with the required hydraulic resistance ratio between a manifold and the supply channels connected thereto (Rₛ₁≥10×Rₘ₁ and Rₛ₂≥10×Rₘ₂). This is because during the initial filling of all channels of the chip with the appropriate phases, it can be seen that each phase first fills the entire manifold before entering the actual channels in all the units.

A related issue during the start-up of operation of a microfluidic chip of the invention is the presence of gas bubbles and their removal. In conventional microfluidic chips that have branched structure for internal fluid supply rather than one single manifold, such gas bubbles typically disturb the flow of a particular branch, which immediately translates into a plurality of droplet generators that are affected by the disturbed flow. So, a significant number of droplet generators will produce droplets that deviate from those that are produced by the remainder of the droplet generators, which translates in less uniformity in the product that is collected from the microfluidic chip as a whole. A microfluidic chip of the invention does not suffer from this problem, since the manifolds inherently have a cross-sectional surface area that is large enough for gas bubbles to propagate fast, which essentially excludes the chance that a gas bubble impairs the flow in more than one of the droplet generators. When a gas bubble is forced through a supply channel of a unit for droplet formation, then this neither affects the flow in supply channels of neighboring units for droplet formation, because the manifold that feeds all the units in a parallel fashion has at least a ten times lower hydraulic resistance.

It is preferred that the units are arranged in a radial fashion, reminiscent of the spokes in a wheel. For example, the units are arranged radially when the discharge channels are arranged radially and/or when one or both supply channels are arranged radially. In a preferred radial arrangement, the discharge channels are arranged with their outlets directed towards the radial center. In other words, the units are arranged side by side in the form of an annulus, which annulus is defined by an inner circle and an outer circle, both circles being concentric. The outlets of the discharge channels then define the inner circle of the annulus.

With such radial arrangement, it is preferred that the units lie in the same plane. Such microfluidic chip is e.g. displayed in FIG. 5. This Figure is a top view of a microfluidic chip (1), displaying a plurality of units (2) for droplet formation which are placed above two circular manifolds (11, 12) for the supply of the first and second phase. The circular manifold (11) comprises a first manifold inlet (11a) and the circular manifold (12) comprises a second manifold inlet (12a). These manifold inlets (11a, 12a) serve to supply a liquid from a fluid supply system or apparatus to the respective manifold. In contrast to the chip (1) displayed in FIG. 1, the chip (1) of FIG. 5 does not really comprise a manifold for the collection of the product phase because all the outlets of the discharge channels arrive in the same space, namely a hole in the chip, which in fact directly forms the manifold outlet (13a). The manifold (13) and the manifold outlet (13a) of FIG. 1 can be regarded as being merged into the single chip outlet (13a) of FIG. 5.

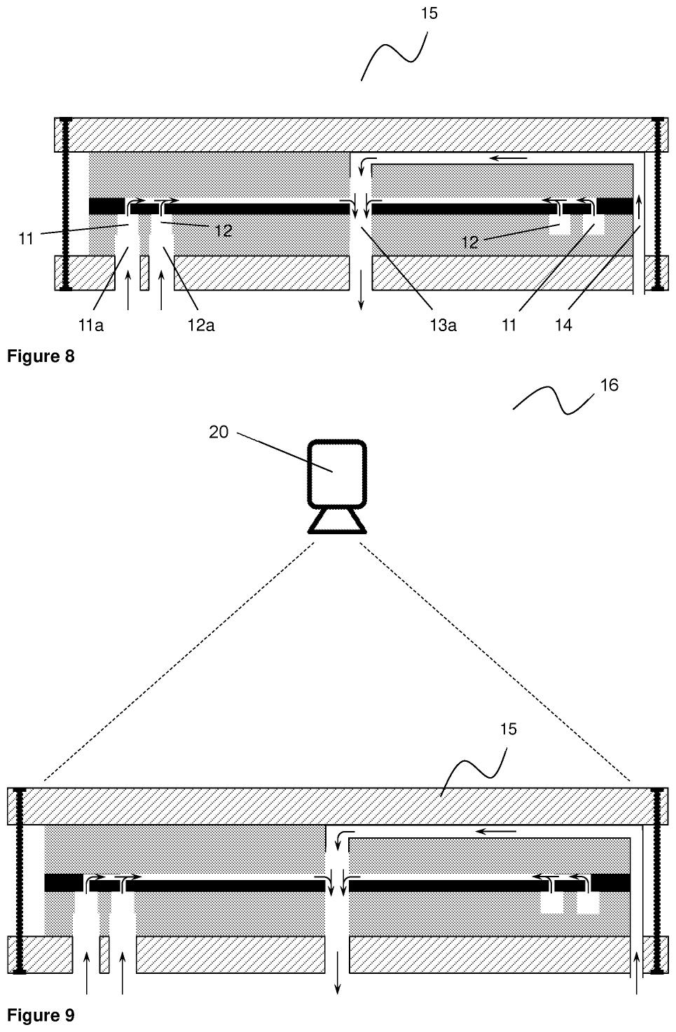

The chips (1) displayed in FIGS. 5-9 have the manifold inlets (11a, 12a) and the manifold outlet (13a) on the same side of the chip (1). In view of the above remark that a manifold inlet or outlet is equivalent to a chip inlet or outlet, respectively, it is equivalent to state here that the chip inlets and the chip outlet are on the same side of the chip. This has certain advantages, which are highlighted below in the description of the cartridge.

In a radial arrangement, the positions of the junctions typically define a circle. This is in principle also the case for other corresponding elements of the units, such as the inlets and the outlets.

In principle, the units in a radial arrangement may also be arranged on a curved surface rather than on a plane. However, the manufacture of chips with such arrangement is more complicated.

Usually, the channels in a chip of the invention are obtained by lithographic methods. Part of the surface of a support plate of e.g. glass, silicon or plastic is then etched to yield grooves (channels without a cover) having a cross-section of a particular shape. For example, the cross-section of the grooves has a rectangular shape, and in a particular case a square shape. The grooves are typically closed by a cover plate on top of the support plate to yield the actual channels. In this way, the channels extend typically in two dimensions over the surface of the support plate, so that all the channels of the chip extend in the same plane.

FIG. 7 is a side-view of a microfluidic chip (1) of the invention and reveals the layered structure of the chip. It comprises a silicon support plate (18) sandwiched between two glass plates (17, 19). The support plate (18) has a thickness of 0.4 mm and the two glass plates (17, 19) each have a thickness of 1.1 mm. This figure demonstrates that all inlets and outlets are on the same side of the chip (the bottom side).

The invention further relates to a cartridge (15) comprising a microfluidic chip as described hereabove, comprising
a first opening coinciding with a first manifold inlet (11a) for supplying the first phase to the first manifold (11) of the microfluidic chip (1);
a second opening coinciding with a second manifold inlet (12a) for supplying the second phase to the second manifold (12) of the microfluidic chip (1);
a third opening coinciding with a manifold outlet (13a) for collecting the product phase from the microfluidic chip (1);

wherein
the units (2) are arranged in such manner that they lie in the same plane or define a curved surface, in particular in such manner that the discharge channels (5) lie in the same plane or define a curved surface;
all of the manifold inlets and all of the manifold outlets are on the same side of the plane or the curved surface.

The cartridge can be seen as a casing around the chip which provides protection to the chip and allows easy manipulation of the chip, e.g. an easy installation into a fluid supply system that contains reservoirs of the different liquid phases that are to be fed through the chip and pump mechanisms (i.e. pumping means) to supply these phases in a controlled way (pressure, flow) to the chip. The installation of the cartridge into the apparatus typically includes its fixation with a simple, predetermined movement at a predetermined pressure resulting in immediate liquid tight connections between the apparatus and the chip.

The cartridge typically surrounds the microfluidic chip at least partly. It comprises at least two openings each coinciding with the at least to inlets of the chip (i.e. the openings are aligned with the inlets), so that outlets of the fluid supply system can be directly connected to the inlets of the chip. These inlets are essentially the inlets of the one or more manifolds. The cartridge also comprises an opening coinciding with the manifold outlet (i.e. chip outlet), allowing the collection of the product phase from the microfluidic chip.

In a cartridge of the invention, the units of the microfluidic chip are arranged in such manner that they form a plane or a curved surface. In other words, stacking the units is primarily performed in two dimensions (plane). They may also be are arranged in three dimensions (curved surface), but preferably only to the extent that there is at least one projection of the chip wherein units are not overlying one another. This also applies to the curved surfaces described above for the arrangement of the units in microfluidic chips without a cartridge.

When all of the manifold inlets and all of the manifold outlets are on the same side of the plane or the curved surface, then all openings of the cartridge that coincide with a manifold inlet or manifold outlet are also positioned on the same side of the cartridge. For example, all openings may be present in the bottom side of a cartridge having a top side and a bottom side. An advantage of a cartridge of the invention is that the other side (e.g. the top side) is accessible for other purposes, since there are no openings and no elements of other attached equipment (such as the pump) at or near this side.

For example, when the units of the chip comprise a transparent layer over the channels, supply and discharge of liquids can be monitored during operation of the chip. The transparent layer is transparent to electromagnetic radiation, for example electromagnetic radiation in the optical domain, in the UV domain, in the IR domain or in combined domains thereof. In this way, for example, the formation of droplets can be monitored. It is also possible to check whether all units are active since dormant units can easily be identified. It is in particular possible to perform the monitoring with a camera, so that photographs and/or films of the chip (and a production process performed thereon) can be made. Accordingly, the invention further relates to an assembly (15) of a cartridge as described above and a camera positioned to record that side of the microfluidic chip in the cartridge that is opposite to the side comprising the manifold inlets and the manifold outlet, wherein the channels in the chip are visible through a transparent plate.

FIG. 11 displays a micrograph of a section of a microfluidic chip of the invention that is in operation. The units for droplet formation are covered with an optically transparent layer. This allows a clear and real-time view of all the channels for the supply and discharge of liquids. This also allows to provide a direct graphical evidence of the uniformity of the product phase.

Another advantage is that the chip can be illuminated with radiation when the units of the chip comprise a layer over the channels that is transparent to the radiation used for the illumination. This can be used to perform radiation-induced reactions in the prepared droplets, for example the polymerization of monomers that are present in the droplets (e.g. acrylate monomers in combination with a UV lamp), which can be used to convert the droplets into solid particles. This opens the way to in-line post processing of droplets that are formed in a microfluidic chip. Accordingly, the invention further relates to an assembly (21) of a cartridge as described above and a source of radiation to illuminate that side of the microfluidic chip in the cartridge that is opposite to the side comprising the manifold inlets and the manifold outlet, wherein the radiation is capable of reaching an inner volume of the channels, in particular the discharge channels, through a plate covering the channels, which plate is transparent to the radiation used for the illumination.

The orientation of a cartridge of the invention during use is typically one wherein the openings are oriented downwards (i.e. to the surface of the Earth). In this way, gravity can be used to collect the product phase, which may then advantageously occur below the cartridge.

The collection of the product phase is usually aided by allowing a carrier fluid to flow through the product phase manifold (13) to thereby take up the product phase and transport it to the manifold outlet (13a). In case the units in the chip are arranged in a radial fashion, then the carrier fluid is typically supplied from the top side of the cartridge (where there are no inlet and outlet openings) and then flows downwards through the central manifold outlet (13a), aided by gravity. The supply of the carrier fluid from the top does however not necessitate an inlet on top of the cartridge, which would be undesirable as explained above. As displayed in FIGS. 6 and 7, it is possible to position the inlet of the carrier fluid on the bottom side of the chip. This is performed by creating a channel (14) which supplies the carrier fluid by guiding it from the bottom along the side of the chip (1) and along the top of the chip (1) towards the radial center. From there, the carrier liquid will take up the product phase when passing the discharge channels (5) of the units (2) during its descent through the central manifold outlet (13a). Since the channel (14) passes over the units at the top side of the chip, it blocks a small part of the sight on the chip from the top side of the cartridge. In addition, when radiation is emitted from a radiation source with the aim to illuminate the discharge channels of the chip, the channel (14) blocks part of this radiation. This is however not much of a problem since the liquid in channel (14) and the channel (14) itself can be made transparent for the radiation to which channels will be exposed. Else, the channel (14) can be integrated in the same plane as the discharge channels by replacing some of the discharge channels.

It was found advantageous to operate a plurality of microfluidic chips according to the invention simultaneously from one external fluid supply system. This means that they are connected in a parallel fashion to the fluid supply system. The particle size distribution of droplets that are obtained with the different microfluidic chips connected appeared to be substantially identical. This opens the way to substantial upscaling of the production of high quality droplets with microfluidic technology. Parallelization of conventional microfluidic chips, on the other hand, gives particle size distributions that severely vary from chip to chip.

Accordingly, the invention further relates to a system for forming droplets, the system comprising
a first fluid supply system for supplying the first phase to the first manifold of a microfluidic chip (1) as described hereabove;
a second fluid supply system for supplying the second phase to the second manifold of a microfluidic chip (1) as described hereabove;
one or more microfluidic components, which one or more microfluidic components are
   one or more microfluidic chips (1) as described hereabove; or
   one or more a cartridges (15) as described hereabove; or
   one or more an assemblies (16, 21) as described hereabove;

wherein the first fluid supply system and the second fluid supply system are fluidly connected to the one or more microfluidic components.

In such system,
the number of microfluidic chips (1); or
the number of cartridges (15); or
the number of assemblies (16, 21);
   is usually in the range of 2-100. It may also be in the range of 5-25, in the range of 3-15 or in the range of 4-20.

A microfluidic chip of the invention can be operated when the outlets of a fluid supply system are connected to each of the manifold inlets of a microfluidic chip of the invention (which manifold inlets are in fact also the chip inlets). During operation, the phases are typically supplied by the fluid supply system at a constant pressure, resulting in a constant flow rate at the junction.

Accordingly, the invention further relates to a method for the manufacture of droplets, vesicles, microparticles or nanoparticles, comprising the use of a microfluidic chip (1), a cartridge (15), an assembly (16) or an assembly (21) as described above, wherein
a disperse phase is fed through the first channel (3);
a continuous phase is fed through the second channel (4);
so that a product phase comprising droplets, vesicles, microparticles or nanoparticles is generated in the discharge channel (5) and collected after it is discharged from the discharge channel (5).

In a preferred method, the formation and/or the movement of droplets, vesicles, microparticles or nanoparticles is recorded with a camera. In such method,
an assembly (16) as described above is used; and
the units (2) of the microfluidic chip (1) are recorded with a camera (20), in particular the formation and/or the movement of the product phase is recorded with a camera (20).

In another preferred method, the droplets, vesicles, microparticles or nanoparticles are illuminated with radiation to induce a chemical reaction in the product phase or to perform a sterilization of the product phase. In such method,
an assembly (21) as described above is used; and
the product phase is illuminated with radiation to induce a chemical reaction in the product phase or to perform a sterilization of the product phase.

In a particularly preferred method, the cartridge comprises a microfluidic chip of the invention, wherein
the units (2) are arranged side by side in the form of an annulus, which annulus is defined by an inner circle and an outer circle, both circles being concentric;
the outlets of the discharge channels (5) define the inner circle of the annulus, so that the outlets of the discharge channels (5) merge in a central common space which is in fluid connection with a manifold outlet (13a) for the outlet of a product phase;
the chip optionally comprises a channel for feeding the central common space with a carrier fluid that is capable of taking up the product phase and transporting it to the manifold outlet (13a).

1. Microfluidic chip comprising at least two units for droplet formation, each unit comprising
a first supply channel for supplying a first phase, comprising a first inlet for the inlet of the first phase;
a second supply channel for supplying a second phase, comprising a second inlet for the inlet of the second phase;
a discharge channel for discharging a product phase, comprising an outlet for the outlet of the product phase;
wherein
the first and second supply channel converge at a junction to the discharge channel;
the first supply channel has a hydraulic resistance Rₛ₁ to flow of a particular fluid and a minimal cross-sectional surface area MSAₛ₁ along at least part of the supply channel;
the second supply channel has a hydraulic resistance Rₛ₂ to flow of the particular fluid and a minimal cross-sectional surface area MSAₛ₂ along at least part of the supply channel;
the discharge channel has a hydraulic resistance R_{d} to flow of the particular fluid and a minimal cross-sectional surface area MSA_{d} along at least part of the discharge channel;
wherein the microfluidic chip comprises
a first manifold for simultaneously supplying the first phase to the first supply channels of the units;
a second manifold for simultaneously supplying the second phase to the second supply channels of the units; and
wherein Rₛ₁≥2×R_{d} and/or Rₛ₂≥2×R_{d}.

2. Microfluidic chip according to claim 1, wherein MSA_{d}≥2×MSAₛ₁ and/or MSA_{d}≥2×MSAₛ₂, in particular wherein MSA_{d}≥10×MSAₛ₁ and/or MSA_{d}≥10×MSAₛ₂.

3. Microfluidic chip according to claim 1, wherein Rₛ₁≥5×R_{d} and/or Rₛ₂≥5×R_{d}, in particular wherein Rₛ₁≥10×R_{d} and/or Rₛ₂≥10×R_{d}, more in particular wherein Rₛ₁≥50×R_{d} and/or Rₛ₂≥50×R_{d}.

4. Microfluidic chip according to claim 1,
wherein
MSA_{d}≥2×MSAₛ₁ and MSA_{d}≥2×MSAₛ₂ and Rₛ₁≥10×R_{d};
in particular wherein
MSA_{d}≥5×MSAₛ₁ and MSA_{d}≥5×MSAₛ₂ and Rₛ₁≥20×R_{d};
more in particular wherein
MSA_{d}≥10×MSAₛ₁ and MSA_{d}≥10×MSAₛ₂ and Rₛ₁≥40×R_{d}.

5. Microfluidic chip according to claim 1,
wherein
the first manifold comprises a first manifold inlet for the inlet of the first phase;
the first inlets of the first supply channels are connected to the first manifold by fluid connections that are present along the first manifold; and
a hydraulic resistance Rₘ₁ to flow of the particular fluid is defined for a first section of the first manifold, the first section extending from the first manifold inlet to a most remote fluid connection that is most remote from the first manifold inlet, measured along the first manifold;
wherein
the second manifold comprises a second manifold inlet for the inlet of the second phase;
the second inlets of the second supply channels are connected to the second manifold by fluid connections that are present along the second manifold;
a hydraulic resistance Rₘ₂ to flow of the particular fluid is defined for a second section of the second manifold, the second section extending from the second manifold inlet to a most remote fluid connection that is most remote from the second manifold inlet, measured along the second manifold; and
wherein Rₛ₁≥10×Rₘ₁ and Rₛ₂≥10×Rₘ₂, in particular wherein Rₛ₁≥20×Rₘ₁ and Rₛ₂≥20×Rₘ₂.

6. Microfluidic chip according to claim 5,
wherein
MSA_{d}≥2×MSAₛ₁; and
MSA_{d}≥2×MSAₛ₂; and
Rₛ₁≥10×R_{d}; and
Rₛ₂≥10×R_{d}; and
Rₛ₁≥10×Rₘ₁; and
Rₛ₂≥10×Rₘ₂;
in particular wherein
MSA_{d}≥5×MSAₛ₁; and
MSA_{d}≥5×MSAₛ₂; and
Rₛ₁≥20×R_{d}; and
Rₛ₂≥20×R_{d}; and
Rₛ₁≥20×Rₘ₁; and
Rₛ₂≥20×Rₘ₂;
more in particular wherein
MSA_{d}≥10×MSAₛ₁; and
MSA_{d}≥10×MSAₛ₂; and
Rₛ₁≥40×R_{d}; and
Rₛ₂≥40×R_{d}; and
Rₛ₁≥40×Rₘ₁; and
Rₛ₂≥40×Rₘ₂.

7. Microfluidic chip according to claim 5, wherein
the first manifold has a cross-sectional surface area SAₘ₁; and
the second manifold has a cross-sectional surface area SAₘ₂;
and wherein SAₘ₁ and SAₘ₂ are, independently of one another, in the range of 2,500-50,000,000 μm² and/or MSAₛ₁ and MSAₛ₂ are, independently of one another, in the range of 10-10,000 μm².

8. Microfluidic chip according to claim 1, wherein MSAₛ₁ and MSAₛ₂ are in the range of 10-10,000 μm² and/or MSA_{d} is in the range of 25-250,000 μm².

9. Microfluidic chip according to claim 1, wherein the at least two units further comprise a third supply channel for supplying the first phase, for supplying the second phase or for supplying a third phase, wherein
the third supply channel converges at a junction to the discharge channel;
the third supply channel has a hydraulic resistance Rₛ₃ and a minimal cross-sectional surface area MSAₛ₃ along at least part of the supply channel;
wherein one or more hydraulic resistances selected from the group of Rₛ₁, Rₛ₂ and Rₛ₃ are at least 2 times the hydraulic resistance R_{d}.

10. Microfluidic chip according to claim 1, wherein one of the supply channels protrudes from the junction into the discharge channel.

11. Microfluidic chip according to claim 1, wherein the microfluidic chip comprises at least 10 of the units for droplet formation, preferably at least 50.

12. Microfluidic chip according to claim 1, wherein the units are arranged in such manner that they lie in the same plane or define a curved surface, in particular in such manner that the discharge channels lie in the same plane or define a curved surface.

13. Microfluidic chip according to claim 1, wherein
the units are arranged side by side in the form of an annulus, which annulus is defined by an inner circle and an outer circle, both circles being concentric;
the outlets of the discharge channels define the inner circle of the annulus, so that the outlets of the discharge channels merge in a central common space which is in fluid connection with a manifold outlet for the outlet of a product phase;
the chip optionally comprises a channel for feeding the central common space with a carrier fluid that is capable of diluting the product phase and transporting it to the manifold outlet.

14. Cartridge comprising a microfluidic chip according to claim 1, the cartridge comprising
a first opening coinciding with a first manifold inlet for supplying the first phase to the first manifold of the microfluidic chip;
a second opening coinciding with a second manifold inlet for supplying the second phase to the second manifold of the microfluidic chip;
a third opening coinciding with a manifold outlet for collecting the product phase from the microfluidic chip;
wherein
the units are arranged in such manner that they lie in the same plane or define a curved surface, in particular in such manner that the discharge channels lie in the same plane or define a curved surface;
all of the manifold inlets and all of the manifold outlets are on the same side of the plane or the curved surface.

15. Assembly comprising a cartridge of claim 14 and a camera positioned to record that side of the microfluidic chip in the cartridge that is opposite to the side comprising the manifold inlets and the manifold outlet, wherein the channels in the microfluidic chip are visible and/or recordable by the camera through a transparent plate.

16. Assembly comprising a cartridge of claim 14 and a source of electromagnetic radiation to illuminate that side of the microfluidic chip in the cartridge that is opposite to the side comprising the manifold inlets and the manifold outlet, wherein the radiation is capable of reaching an inner volume in at least the discharge channels through a plate that is transparent to the electromagnetic radiation used for the illumination.

17. System for forming droplets, comprising
a first fluid supply system for supplying the first phase to the first manifold of the microfluidic chip according to claim 1;
a second fluid supply system for supplying the second phase to the second manifold of the microfluidic chip;
one or more microfluidic components, which one or more microfluidic components are
one or more microfluidic chips; or
one or more a cartridges; or
one or more an assemblies;
wherein the first fluid supply system and the second fluid supply system are fluidly connected to the one or more microfluidic components.

18. System for forming droplets according to claim 17, wherein
the number of microfluidic chips; or
the number of cartridges; or
the number of assemblies;
is in the range of 2-100 or in the range of 5-20 or in the range of 3-10.

19. Method for the manufacture of droplets, vesicles, microparticles or nanoparticles, comprising the use of a microfluidic chip according to claim 1, a cartridge or an assembly, wherein
a disperse phase is fed through the first channel;
a continuous phase is fed through the second channel;
so that a product phase comprising droplets, vesicles, microparticles or nanoparticles is generated in the discharge channel and collected after it is discharged through the discharge channel.

20. Method according to claim 19, wherein
an assembly is used; and
the units of the microfluidic chip are recorded with a camera, in particular wherein the formation and/or the movement of the product phase is recorded with a camera.

21. Method according to claim 19, wherein
an assembly is used; and
the product phase is illuminated with electromagnetic radiation to induce a chemical reaction in the product phase or to perform a sterilization of the product phase.
